(19) United States
(12) Patent Application Publication
(10) Pub. No.: US 2011/0093885 A1
(43) Pub. Date: Apr. 21, 2011

(54) BOOKMARK CALIBRATION FOR VIDEO ON DEMAND APPLICATIONS INCORPORATING DYNAMIC ADVERTISING

(75) Inventor: Dheeraj Ravula, Roswell, GA (US)

(73) Assignee: Tandberg Television Inc.

(21) Appl. No.: 12/603,090

(22) Filed: Oct. 21, 2009

(51) Int. Cl. H04N 7/025

(52) U.S. Cl. 725/32; 725/93

(57) ABSTRACT

A video on-demand (“VOD”) system receives a request for a VOD program, thereby generating a VOD session for the viewer. The VOD system generates a dynamic playlist incorporating at least one advertisement, where the playlist is provided to the VOD server, causing said VOD server to stream the playlist to the viewer. Upon suspension of viewing the VOD program by the viewer, the VOD system terminates the VOD session. Upon receiving a subsequent request from the viewer for the same VOD program, a second VOD session is established by the VOD system with a second dynamic playlist incorporating at least one other advertisement. The VOD system streams the program beginning at the same point in the program where the original interruption occurred.

### FIELD OF INVENTION

The present invention is generally directed to video on-demand systems and methods, and more specifically to calibrating bookmarks indicating where resumption should occur for a resumed video on-demand session when dynamic advertising is incorporated into the playlist.

### BACKGROUND OF THE INVENTION

Video on-demand systems allow a user to select a program for viewing from a library of movies. Such systems offer the ability of users to view programs at their convenience, rather than adjusting their viewing schedules to when programs are being broadcasted by a video service provider, such as a cable services provider (“CSP”).

Other capabilities have been defined to provide convenience to viewers. One such set of capabilities involves various functions that include capabilities referred to as “pause” and “resume.” These functions allow a user to temporarily interrupt viewing a program, so that the user does not miss any of the program contents during the interruption. One such system is found in U.S. Pat. No. 6,804,825 entitled Video On Demand Methods And Systems, which discloses one approach for interrupting and resuming a program.

While “pausing” a program provides a viewer a convenient mechanism for interrupting viewing of a program, in some instances this is inadequate. The viewer may have started viewing a VOD program, but for various reasons may be forced to terminate viewing for a longer period of time than is allowed when pausing a program. In some embodiments, the session established with the viewer is terminated, and in such cases, requesting the VOD program is treated as a wholly new request. Thus, it is not possible for the system to return to where the user left off.

Further, in many cases, the video on-demand (“VOD”) service is provided to the viewer at no additional charge. The CSP may provide advertising in conjunction with the playback of the program to offset costs associated with the service. One such approach involves the service provider creating a digital video file with the ads combined with the movie. Then, this entire file is treated as a single program. In this embodiment, the ads are pre-determined and fixed. Thus, there is no flexibility with the type of ads, their location, etc. This type of ad placement is static.

Another approach for inserting ads involves selecting the ads and determining their placement into a program at the time the program is requested by the viewer. Because computer systems can quickly select and place the portions of the ad with the program, such dynamic ad placement approaches are more flexible. The definition of the various sections and when their played is called a “playlist.” Once such system for providing ads is disclosed in WO 2005/086865, based on PCT/US2005/00777 filed on Mar. 9, 2005, entitled Digital Ad Insertion For Video On-Demand. Such systems allow selection of the ad in conjunction with a VOD program using various advertising scheduling criteria.

A static ad placement is more-or-less a fixed digital video file, and the playlist can be thought of at one level as a single file. Interrupting this VOD program and resuming it at the same location is not difficult. However the presence of dynamic ads comprising a playlist can complicate the process, as discussed herein. Therefore, systems and methods are required to accommodate interrupting a VOD program where dynamic ads are involved.

### BRIEF SUMMARY OF THE INVENTION

In one embodiment of the invention, a system is defined that initiates a VOD session with a viewer of a cable service provider, wherein advertisements are dynamically inserted into the VOD session, and the system allows the VOD session to be suspended, and upon resumption, the user is returned to the point in the program where they left off. Upon suspension of the session, the system maintains a feature bookmark indicating where in the program the user left off, and upon resumption of a second session based on the first session, the system calculates the resumption location, called a session bookmark, using the feature bookmark based on the current dynamically inserted advertising.

In another embodiment of the invention, a method is defined for providing a VOD program to a user, wherein a feature bookmark for a user is recorded by a system, allowing the user to suspend and resume of the program at a different time, but yet resume at the same point where the user interrupted the program.

These are only illustrative embodiments, and they are not intended to limit the scope of the claims beyond the specification indicated herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of components used to provide a video on-demand service to a CSP viewer;

FIG. 2 illustrates one embodiment of a session for providing a VOD program to a CSP viewer;

FIG. 3 illustrates one embodiment of resuming a VOD session for a CSP viewer;

FIG. 4 illustrates further details regarding a session for providing the VOD program of FIG. 2;

FIG. 5 illustrates further details regarding resuming a VOD program for a viewer involving two separate sessions;

FIG. 6 illustrates one embodiment of a system for determining where to resume a VOD program in a second session for a viewer;

FIG. 7 illustrates one embodiment of mapping resumption from one session to another session; and

FIG. 8 illustrates one process executed on a processing system for resuming the program in a subsequent VOD session.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

Although certain methods, apparatus, systems, and articles of manufacture have been described herein, the scope of coverage of this patent is not limited thereto. To the contrary, this patent at least covers various apparatus, systems, and articles of manufacture fairly falling within the scope of the appended claims either literally or under the doctrine of equivalents.

As should be appreciated, the embodiments may be implemented in various ways, including as methods, apparatus, systems, or computer program products. Accordingly, the embodiments may take the form of an entirely hardware embodiment or an embodiment in which computing hardware, such as a processor or other special purpose devices, is programmed to perform certain steps. Furthermore, the various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

The embodiments are described below with reference to block diagrams and flowchart illustrations of methods performed using computer hardware, apparatus, systems, and computer-readable program products. It should be understood that each block of the block diagrams and flowchart illustrations, respectively, may be implemented in part by computer-readable program instructions, e.g., as logical steps or operations executing on a processor in a computing system or other computing hardware components. These computer-readable program instructions are loaded onto a computer, such as a special purpose computer or other programmable data processing apparatus, to produce a specifically-configured machine, such that the instructions which execute on the computer or other programmable data processing apparatus implement the functions specified in the flowchart block or blocks.

The “program” that is selected by the viewer using a VOD service is illustrated herein as a video based movie, but the contents of the program may include other types, such as sports programs, documentaries, etc. Thus, “program” and “movie” are used interchangeably as illustrative examples. Further, although the principles of the present invention are disclosed in terms of viewing a program, the principles can apply to listening to an audio program, playing a video game, etc. Further, although the principles of the present invention are disclosed in terms of a cable service provider, the principles can apply to various other types of video service providers, using other technologies, such as satellite distribution of video signals, fixed wireless transmission, mobile wireless transmission, and Internet based technologies. The VOD program that is available to subscribers of the cable service provider is available on an “on-demand” basis, and some referred to as “movies on-demand”, pay-per-view, video on-demand, or other terms. The program can be provided without any specific fees, or on a per-usage fee basis. The embodiments described here are intended to describe the best mode of using the invention.

The advertisement inserted can be a commercial that is paid for by a sponsor, or non-paid commercial, such as a public service advertisement. It may also include information video segments, which indicate the source or producer of a program, or a “bumper”, which is a well-known video segment inserted for indicating the rating content of a program (e.g., “this program is rated “G” for general audiences”). Other informative video segments may fall within the scope of an advertisement.

### Service Description

The description of service supported by one embodiment of the present invention is described below. Incorporation of the architecture is provided to facilitate how the service works, but it should be recognized that there are various alternative embodiment of the architecture that can be used.

Video on-demand systems provide a convenient approach for allowing users to view a program according to the viewer's schedule. Thus, a fundamental aspect of VOD services is the ability to start viewing a program at the viewer's convenience. However, once started, many viewers are not able to view the entirety of the movie in an uninterrupted manner. Distractions involving telephone calls, family interruptions, or other scheduled events typically occur. CSPs have accommodated the hectic schedules of viewers by providing various control functions that control the playback of the program. These functions are sometimes referred to as “trick” functions, and include “pause,” “resume,” “fast forward,” “freeze,” and “rewind.” These have their origins with tape-based video cassette recorders. The “pause” and “resume” functions allow a user to interrupt their viewing experience, and return when convenient. The point where the movie is paused can be logically thought of as a “bookmark”, as it identifies the location where viewing is to resume. The “pause” function stops the program at the designated point, and the “resume” function starts playing at that same point. In some instances, the system may resume at time (e.g., a few seconds) just before the bookmark, which allows, for example, the audio track to be fully understood or the context of the resumption better appreciated. However, the present invention can apply to whether or not this variation is incorporated.

In some instances when viewing a VOD program, the ability to “fast forward” may be limited. As will be seen, advertisements may be inserted into the VOD program, and the user may be limited as to when they can skip over the advertisements.

Typically, there is a time limit to the duration for which a user can “pause” the program. Establishing a VOD viewing (or session) requires allocation of network resources for that viewer. If the viewer is then not going to view the program, then at some point it is appropriate to then release the allocated resources. In some instances if the interruption is too long, the system will exit (e.g., terminate) the VOD program in its entirety, or resume playing the program automatically. Another action which can end a VOD session is for the viewer to turn off the television or the set top box, during the VOD program. As some point, the service provider recognizes this and ends the VOD session. If the user selects the program anew from the VOD menu, then a new session is started. Ideally, when resuming a session, the VOD service would allow a viewer to select a VOD program, view a portion of the program, exit the viewing session, and then resume the VOD program at their convenience without having to re-select the VOD program and view the beginning portion again.

As evident from the above, there is a distinction between “pausing” a VOD program for a short duration (which maintains the VOD session), and “suspending” the VOD program for a longer time, which ends the VOD session. The present invention involves the latter. Thus, in the context of the present invention, “suspending” a VOD program means terminating the VOD session, and “resumption” means reestablishing another VOD session but one which is recognized as starting a the point previously left off (or thereabouts).

In many instances, a CSP may offer a library of VOD programs at no additional cost, because the viewing of the VOD program may require viewing associated advertising. The selection of advertising may be determined at time of selection. This is referred to as the “playlist”, which is the definition of the segments and relationship thereof. Consequently, if the user resumes a VOD in a new session, then a playlist is determined, although the resumption occurs at the same point originally left off. In one embodiment of the invention, the system returns the user to the same location of the program in a new playlist comprising dynamically determined advertisements.

### Architectural Overview

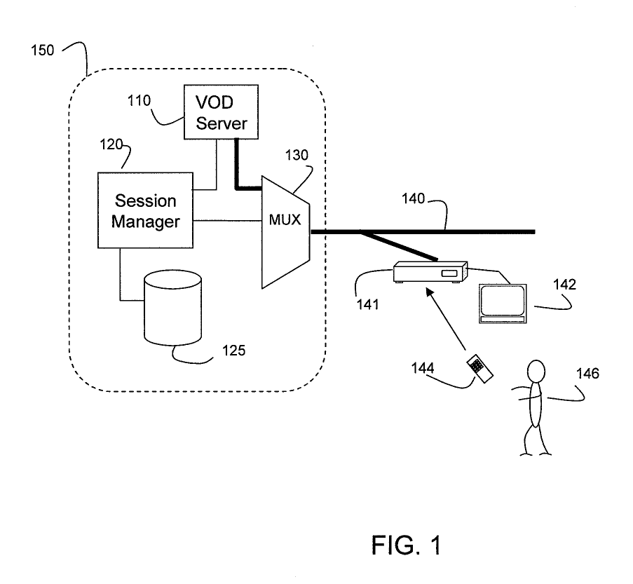

One overview of a VOD system incorporating one embodiment of the present invention is shown in FIG. 1. In FIG. 1, a CSP's VOD system 150 is centrally located in a headend. In other embodiments, the components may be geographically dispersed and communicate with each other via a LAN, WAN, or public network (such as the Internet), but for illustration purposes they are shown in a single location. In other embodiments, there can be a number of components, in different numbers relative to other components. However, for convenience purposes, a single component of each type is shown. Further, the logical functions of the components can be re-distributed, recombined in various ways, and implemented using different platforms, as will be seen. Further components can be present to accomplish or augment the functions described.

In FIG. 1, the VOD service is accessed by a viewer (user) 146, who is shown herein as a subscriber of the cable service provider. The viewer operates a remote controller 144, which communicates with a set top box 141. The viewer may be able to indicate a function on the remote control, such as selecting a VOD service. This causes the set top box to display a series of VOD titles on the television 142 from which the user can search and select a movie according to various well known techniques known in the art. After selecting the movie, the set top box 141 communicates the request over a cable distribution network 140 to the cable service provider's headend 150. The cable distribution network is not limited to any particular technology or topology, and can rely on any variety of combinations of components, from different manufacturers, etc.

The cable distribution network 140 is connected typically to a multiplexor 130. At a high level, the request for the VOD movie is passed to a Session Manager 120 which analyzes the request, determines if resources are available, ascertains the subscriber's service level, allocated the resources, and instructs the VOD server to play out the requested program. In addition, the Session manager 120 may determine the playlist and instruct the VOD server to first play one or more advertising segments. These ads are sequentially provided to the multiplexer 130, which are streamed over the cable services network 140. After the advertisement(s) is shown, the VOD server 110 then streams out the program requested. During this processing, the workflow manager may access a database 125 which store various data, such as the subscriber's service level, location of the appropriate VOD server storing the requested program, the appropriate ads to select, etc.

As a consequence, the Session Manager is aware of the user's viewing of the program, and maintains this information. In this manner, the Session Manager can ensure that sufficient resources are allocated to the viewer for viewing the program. The user then sees the sequence of ads and the feature program as defined by the playlist.

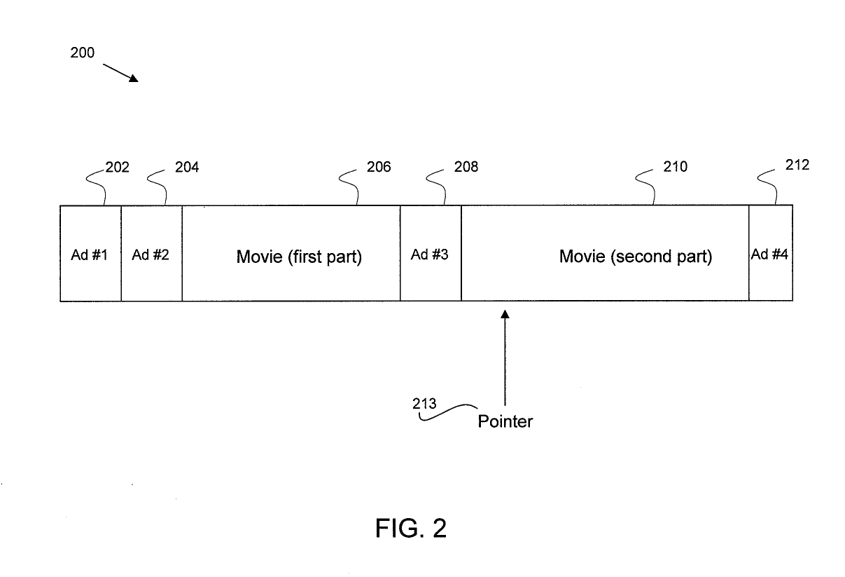

FIG. 2 illustrates one possible sequence 200 of a playlist to be presented to the user. The playlist is created by the Session Manager (or another system interacting with the Session Manager) and is represented by the image in FIG. 2. FIG. 2 illustrates what is scheduled to be show, although the user may not necessarily view the entire playlist. However, FIG. 2 is useful for illustrating the relative placement of ads with respect to the feature program. In FIG. 2, the selected program is prefaced by Ad #1 202 and Ad #2 204. These ads are termed “pre-roll” ads since they occur prior to the showing of the movie (the act of starting a movie is sometimes referred to as “rolling” the film). The movie, also known as the “feature” program or “feature presentation” (e.g., as in a feature film) is interrupted by a “mid-roll” Ad #3 208. Thus, Ad #3 divides the feature into two portions—there is a first part of the movie 206, and a second part of the movie 210. Ads 212 following the movie are called “post-roll” ads. As noted, there may be additional ads inserted additional points. Thus, the movie could be broken into three portions, or additional post-roll or pre-roll ads may be inserted.

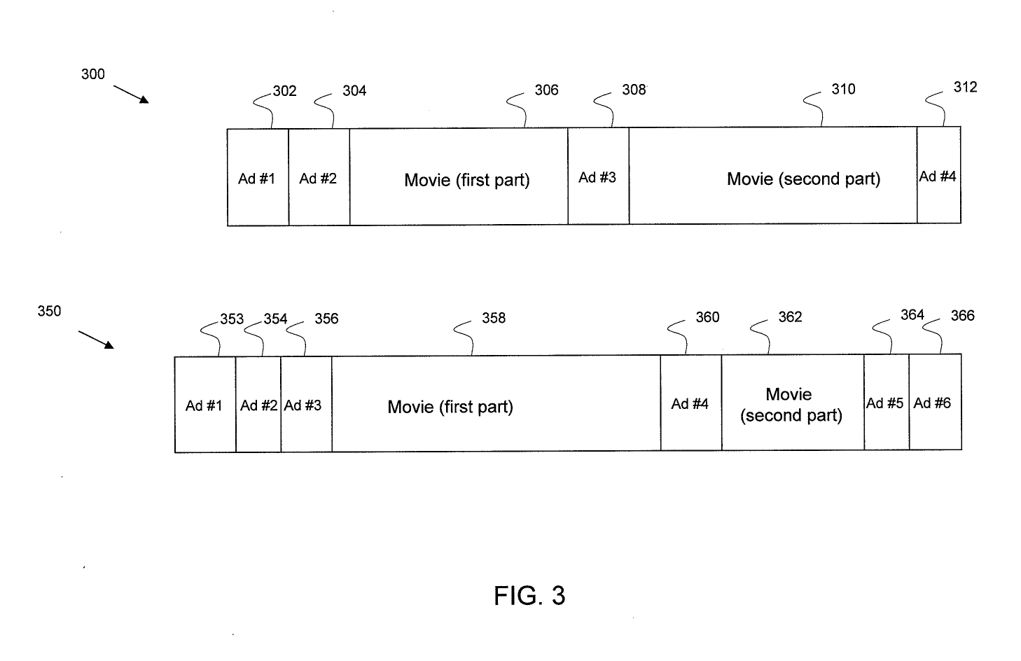

When a user “pauses” (not “suspends”), a pointer 213 is created and stored by the VOD system 150, which the viewer can then resume. Returning to FIG. 1, because the Session Manager 120 retains knowledge of the session, storing the pointer (e.g., bookmark or time offset) and then resuming at the bookmark for that subscriber is straightforward. During this time, both the Session Manager and the VOD server are maintaining a VOD session for that user, although the VOD server may not be streaming out video when a “pause” occurs. However, because it is presumed that the user will soon resume the video, the VOD system resources are reserved for that user. If the user does not resume within a defined time period, the Session Manager will release the allocated resources and terminate the session. Such resources may include multiplexer (e.g., QAM) resources, bandwidth allocation, buffer or memory space, etc. The VOD System will allow the user to resume the playback within a certain timeframe, but this requires establishing a second session. Thus, pausing a VOD session, and then resuming the session, is well known in the art. This invention concerns interrupting a first session, and then resuming the program during a second session which is linked in some manner with the first session. This is illustrated in FIG. 3.

FIG. 3 illustrates two sessions 300, 350 where the user has selected the same movie, but discontinued the first session 300 and resumed the movie, thereby causing a second session 350 to be generated. As noted, a playlist comprising a dynamically selected set of ads to be played during VOD session is created at the time the request for the VOD program is made. Thus, session 300 illustrates one playlist comprising an arrangement of pre-roll ads 302, 304, a first movie segment 206, a mid-roll ad 308, a second movie segment 310, and a post-roll ad 312. For convenience purposes, this playlist mimics the same format of the playlist shown in FIG. 2.

If the user were to initiate another session for the same VOD program (referred to as resuming a suspended VOD program), the VOD system would generate another playlist of ads, as show in session 350. Because the ads are dynamically selected at the time the session is started, the determination of the ads in the second session may differ from the ads selection for the first session, even though the selected movie and the viewer are the same. Thus, in FIG. 3, the second session 350 may comprise three (not two) pre-roll ads, Ad #1 353, Ad #2, 354, and Ad #3 356. Further, the placement of Ad #4 360 may occur at a different part within the feature program. Further, there may be two (not one) post-roll ads, Ad #5 and Ad #6. The Session Manager typically does not “remember” the playlist for a given user for a given VOD program, nor use it when generating a second playlist.

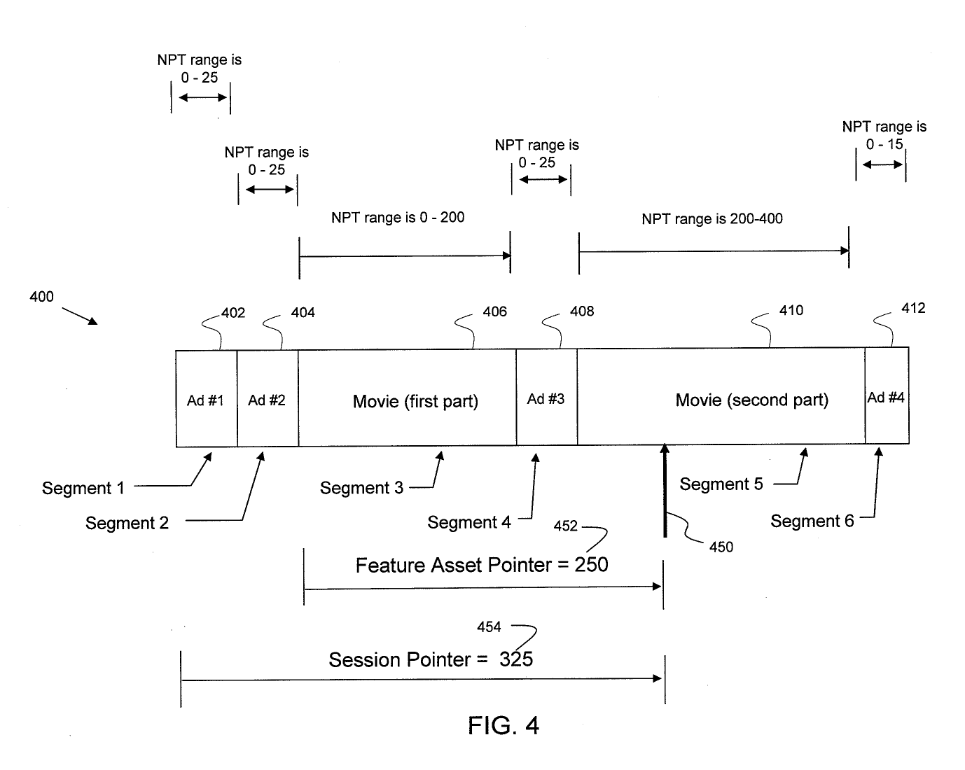

To further define various terms, FIG. 4 illustrates that a session 400 can comprise a number of “segments.” In this embodiment, there are six segments, which comprise the various ad segments and the feature (movie) segments. An “asset” is a broad term that has various meanings in the industry, but as used herein includes, but is not limited to, a digital video file that represents an ad or a movie. Thus, in FIG. 4, there are five assets. Specifically, there are four Ad assets (Ad #1, Ad#2, Ad#3, and Ad#4), and one movie asset (comprised of a first movie segment 406 and a second movie segment 410).

Each asset is associated with a concept called a “Normal Play Time” (“NPT”), which indicates a bookmark of a time offset into the asset. In other works, marking a location in an asset can be conceptually thought of as a bookmark, and in MPEG, the particular mechanism used is the NPT value. This is a number that typically refers to discrete time intervals, which according to industry convention is 1/1000 of a second. Thus, a NPT value of 1000 would be one second. However, for purposes of illustration herein, a much larger time interval is presumed, so that the NPT values are not so large. The time unit assigned for illustrating the invention is arbitrary, and makes it easier to reference values to illustrate the principles of the present invention. Thus, a typical movie is typically much longer than 400 units using a NPT offset.

In FIG. 4, the various segments of various assets are shown, with the duration of each segment shown as indicated. Thus, segment 1 402, which is Ad #1 402, has a NPT range which can range from 0 to 25. Similarly, Ad #2 404 and Ad #3 408 also have a NPT range of 0 to 25. Ad #4 is shorter, and has an NPT range of 0-15. The movie asset has a NPT range from 0-400. Recall that the asset (not the segment) is assigned herein the NPT range. Thus, the presence of Ad #3 408 is inserted just after the NPT point of 200 in the movie asset.

FIG. 4 also illustrates two concepts associated with the VOD system defining a bookmark in a VOD session. First, assuming the user interrupts the program as indicated by arrow 450, this can be described in two different ways. First, this can be described as a feature bookmark, 452, which is the time offset from the beginning of the feature asset. In this illustration, the feature offset (or NPT pointer) is 250. Second, the point of interruption can also be described as a time offset from the beginning of the session, which includes the pre-roll adds 402, 404. In this illustration, the session NPT pointer is 325. As evident, the offset from the beginning of the session includes the time duration for:

| Segment | Duration |
|---|---|
| Ad #1 | 25 |
| Ad #2 | 25 |
| First Movie Segment | 200 |
| Ad #3 | 25 |
| Portion of Second Movie Segment | 50 |
| Total | 325 |

In some VOD systems, the feature asset pointer may be returned by the VOD server when playing is interrupted (suspended) by a user. This value can then be stored in the Session Manager in conjunction with subscriber (viewer) identifying data. In other instances, the session pointer (e.g., bookmark) may be returned by the VOD server, but because the number of ads, their location, and duration are known, the feature bookmark can be derived by the Session Manager.

Thus, if a VOD session is paused (while retaining the VOD session), the same session pointer or the same feature pointer can be used, because the session is being maintained. However, if the session is terminated (e.g., the viewing of the movie is “stopped” and “started), the situation is more complicated. Assuming the request for starting the VOD session (the second session) will be acted upon by the VOD System as reinitializing a request for a VOD session using the same movie, a new VOD session will be established with potentially new ads, but the same session pointer cannot be used, since the session is different. The feature bookmark may be stored, but the Session Manager has to determine what is the corresponding session pointer using the current playlist.

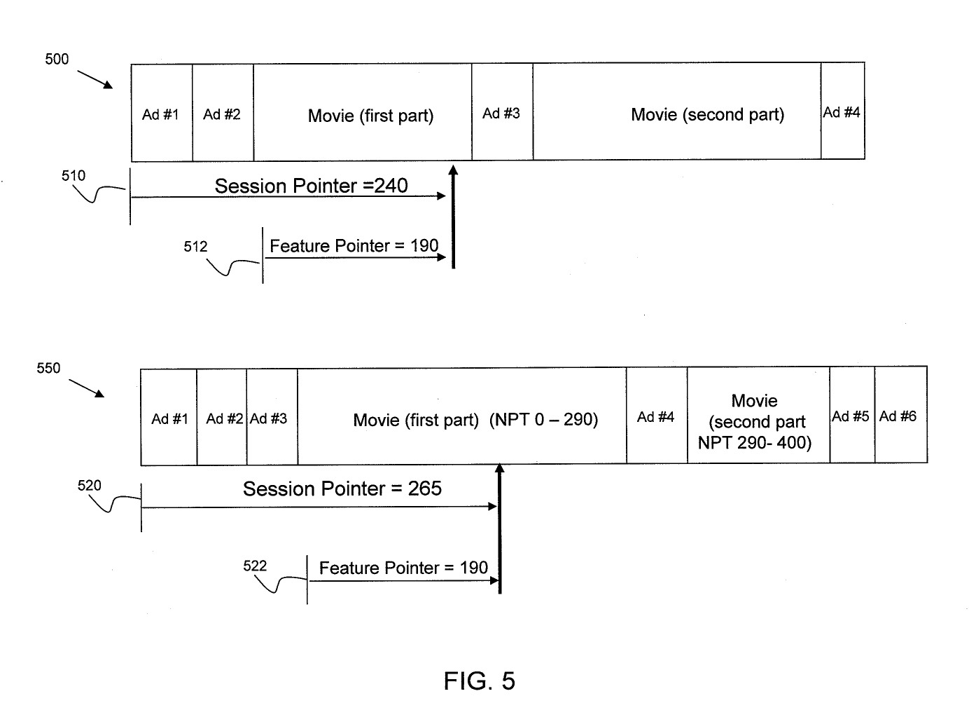

This is shown in FIG. 5. In session 500, the first session is stopped at Session Pointer 240, which is the same as Feature Pointer NPT 190. Once the user stops the session, however, the same session pointer cannot be used, as the session is terminated. The system retains the feature pointer, though, in association with the user.

Upon resuming the movie, which is actually results in creating a new session 550, the same feature pointer 522 is used to determine a new corresponding session pointer 520. In this embodiment, because there is an additional ad (Ad #3) present in the new session 550, the session pointer will be longer than the prior session pointer, in order to have the same feature pointer. When the second session is created, and the playlist for the segments is determined, the Session Manager 120 (or the VOD server 110 in other embodiments) in FIG. 1 can determine the appropriate session pointer by adding the ad time that occurred prior to the feature pointer.

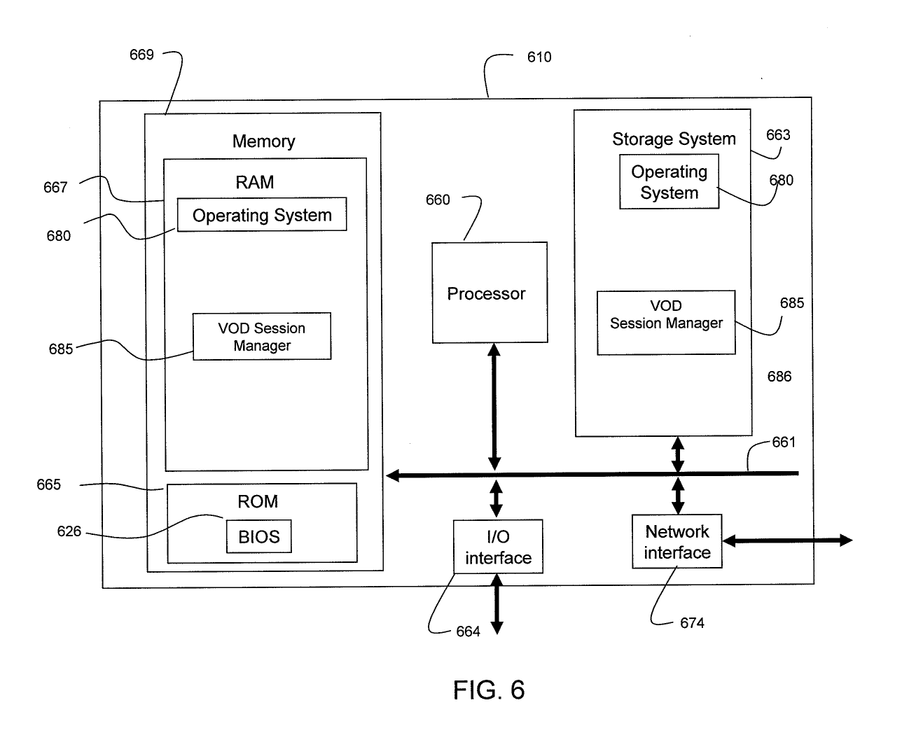

The calculation of the new session pointer can be done by the Session Manager, or the VOD server in different embodiments. Typically, it is done by the Session Manager, because it stores the feature pointer and subscriber identifying information. One embodiment of the processing system performing the determination of the session pointer is shown in FIG. 6.

In FIG. 6, the system 610 is shown comprising a processor 660, which can be a single microprocessor or microcontroller system, although parallel, distributed, or other architectures are possible. The processor interacts with a data storage system 663, which comprises data storing instructions for the operating system 680, and the VOD application 685. In this embodiment, the VOD application processes the “stop” and “start” requests, and calculates the session offset. The VOD application 685 in the storage system is loaded into main memory 667 upon booting up of the system, where a copy of the operating system is also loaded. [Insert rest of text]

The processor 660 typically communicates to primary memory 669 that comprises RAM type memory 667 and ROM type memory 665. The RAM memory stores a copy of the operating system 680 to control the overall system, and the RAM further stores three program modules. The VOD Session Manager module 683 is the module that receives various inputs and calculates the session pointer for resumption of viewing. In other embodiments, this module may be known as a Playlist Manager, but for purposes herein, it is referred to as a VOD session manager, which manages the on-demand session requested by the viewer. The VOD Session Manager also determines whether to treat a request for a movie as a new, independent session, or as a resumption of a prior session suspended by that same viewer. The basic input-output system (BIOS) module 526 is programming code that initially controls the system upon power up.

The storage system 663 may be a separate disk storage system, or may be integrated, and also stores a copy of the operating system 680 and the VOD Session Manager module 683. These are stored so that they can be loaded into main memory 676 upon power up.

The memory and processor communication over a bus 661, and can also send and receive data from an input/output interface 664 or a network interface 674, the latter which is often connected to the Internet (not shown).

A variety of computer systems architectures can be used for the Session Manager, including distributed processors, servers, various types of operating systems, programming languages, etc, that are well known in the art.

In FIG. 5, two separate sessions were illustrated wherein the user suspends a first session during a first feature segment, and resumes a second session. (Note—in this regard, it appears to the user as if the session is suspended and resumed, whereas the VOD System actually links two separate sessions.) In both sessions shown in FIG. 5, the bookmarks occurred in a first feature segment, and hence resumption would occur in the same feature segment. However, in other embodiments, interruption and the resumption may occur in a second feature segment, or at some other location.

Recall that in some embodiments, the VOD server may limit application of certain trick functions at certain times. For example, upon encountering an ad for the first time, the fast forward function may be disabled so that the viewer cannot skip over the ad. Or the fast forward function may only allow proceeding up to a certain point. For example, if a portion of a session is rewound, and then played, a previously seen ad may be encountered. In this case, the fast forward function may be used to skip over the ad, and go to the point where the session last progressed to. A corresponding situation may occur when a user interrupts viewing in a first session when an ad is played. Recall that when resuming, the second playlist may not have the same ad(s). Thus, it is not always possible to resume at the same point of the same segment.

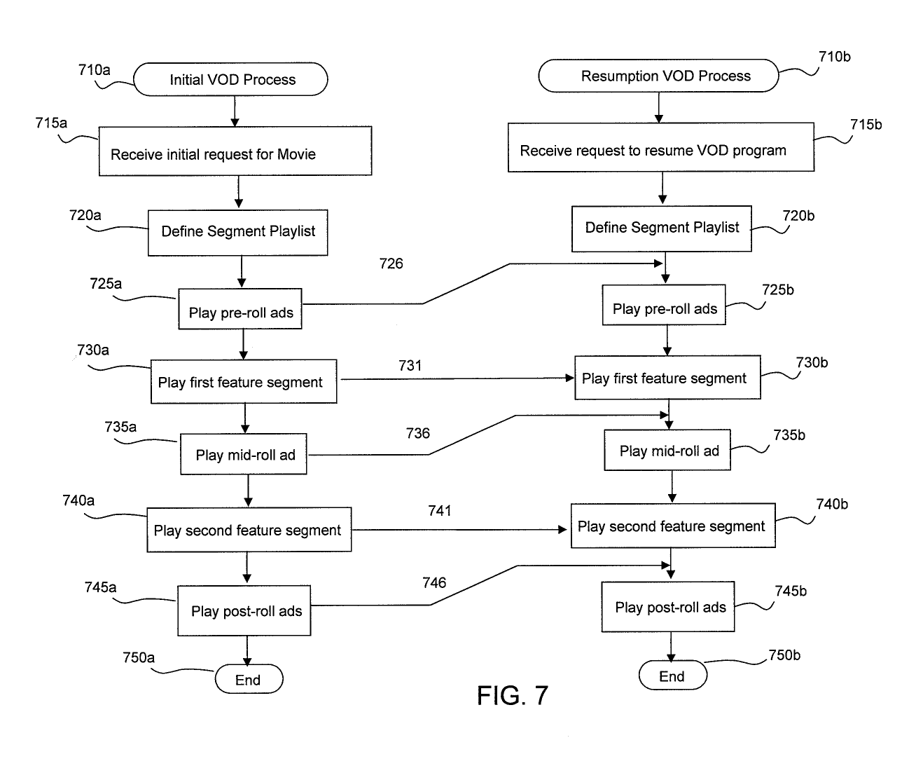

FIG. 7 shows one embodiment of how the system may handle users terminating a session during certain type of ads. In FIG. 7, process 710a represents the first session, and process 710b represents a second session of the same feature for the same user. If the user encounters pre-roll ads 725a in the first session, and then terminates the session during the ad, then when the user initiates a second session, the user will be started at the beginning of any pre-roll ads 725b. This is illustrated by line 726 which shows that the resumption of the session is “backed-up” to the beginning of the pre-roll ads.

Thus, typically the user must view the pre-roll ads (either in the first or second session) before viewing the first feature segment. Should the user stop the session during the first feature segment 730a, or the second feature segment 740a, then the user will be returned via 731 or 741 to the corresponding location in the second session, 730b, or 740b. This can be easily accomplished by the Session Manager storing the bookmark indicated by the feature bookmark, which is not incremented during viewing of an ad. Thus, resuming at a feature bookmark would return the user to the same location of the feature. This is due in part because the insertion of an ad into a feature does not lengthen the feature NPT values. Thus, the NPT counter just before an ad is only incremented after the ad(s) are shown, and the feature play resumes. Thus, the second session would resume at the feature bookmark, just prior to the ad (assuming the ad is located in the same relative position in the feature). However, if the user stops in the middle of a feature segment, then the viewer will be returned to that same location in the second session. If the user attempts to skip over the mid-roll ad 735a in the first session, then upon returning to the feature in a second session, they will be presented with the mid-roll ad in the second session (presuming there is a mid-roll ad), or just before the mid-roll ad in the second session. If the user suspends play during the post-roll ads 745a, then in step 746 they may be returned to a point just before the post-roll ads 745b. In other embodiments, the viewer could resume, instead, at the beginning, namely at the pre-roll ds 725b. Other variations and modifications are possible.

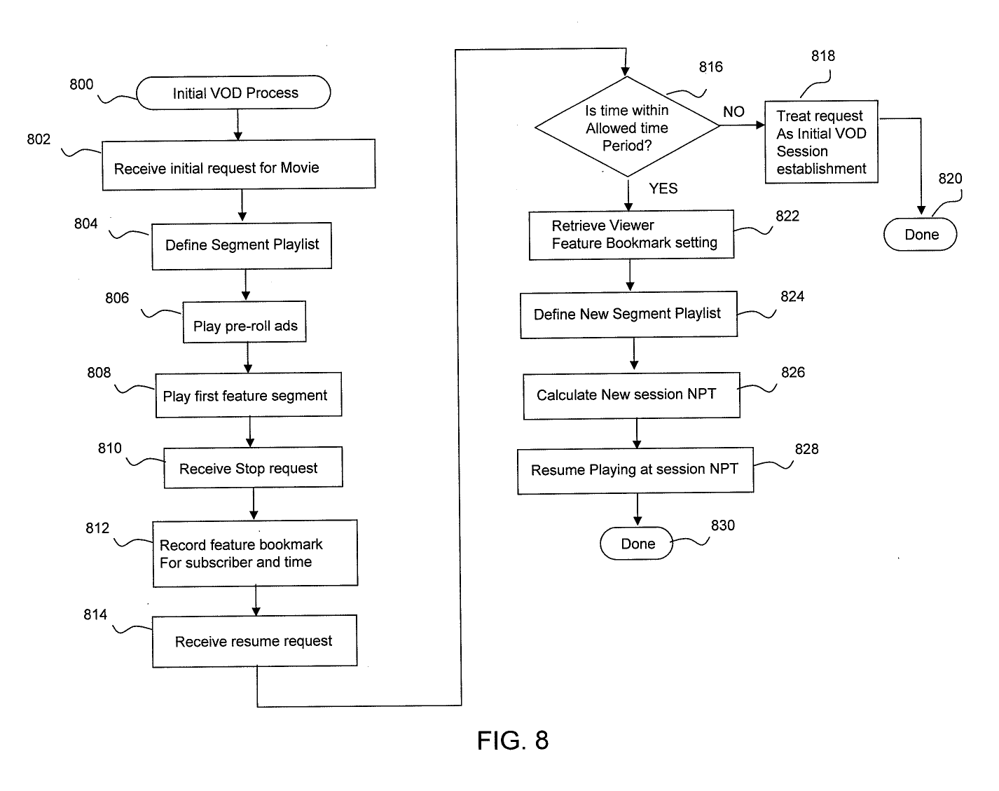

One embodiment of the steps performed by the Session Manager is shown in the process 800 of FIG. 8. In FIG. 8 the process begins with step 802 of receiving the initial request for the movie from the viewer. The Session Manager checks that various resources are available to fulfill the VOD request, and in step 804 determines the playlist. This may occur by the Session Manager querying an advertising system, or the processing may occur within the Session Manager consulting the database 125 of FIG. 1. In either case, the result is that a playlist of the assets and segments therein are defined. Thus, the sequence of segments, beginning with any pre-roll ads, mid-roll ads, post roll ads, and their location relative to the feature are defined by the playlist. Once this is determined, the session playing can begin in step 806 with the streaming of the pre-roll ads. This is then followed by the first feature segment.

A viewer can interrupt (i.e., suspend) the session at any time. As previously noted, this is distinguished from “pausing” the session, which retains the session, and “suspending” the session, which actually results in terminating the session, but wherein the Session Manager stores information allowing the second session to be associated with the first session. In this embodiment, it is presumed that sometime during the streaming of the first feature segment, the viewer terminates the session. This is shown at step 810 with the Session Manager receiving the suspend command (which can occur in various ways, including turning off the television or set top box). The Session Manager then releases various resources associated with the Session, but records in memory the feature and associated feature bookmark for that subscriber for potential future resumption.

At some time in the future, the viewer initiates a second request for the VOD program. The Session Manager may allow a viewer to resume a suspended program within a defined timer period. Thus, a timestamp may also be recorded. Typically, as shown in step 816, this request must fall within a defined time period. For example, the Session Manager may retain the viewer's feature and bookmark for a period time (e.g., 24 hours), after which the request for the VOD program is treated as an initial VOD session in step 818. Specifically, after the defined timer period, the system may not allow resumption at the feature bookmark indicating where the feature was terminated.

Presuming that the request is made within a defined time period, the Session Manager then retrieves the viewer's bookmark information in step 822, which indicates what feature was being viewed, and the value of the feature bookmark when the session was suspended. The Session Manager in step 824 forms a new playlist, which may result in a different selection of ads, of potentially different length, and inserted at different locations in the feature.

In step 826, the Session Manager uses the original feature bookmark to calculate a new session bookmark. In one embodiment, this involves appending the appropriate time offset for any ads in the present session that occur prior to the indicated feature bookmark. For example, returning to FIG. 5, when the first session 500 is terminated, the system knows the feature bookmark is 190. When the second session 550 is started, the Session Manager knows to resume the feature at bookmark 190, but is aware that the playlist includes three pre-roll ads (Ad #1, Ad #2, Ad #3) which are 25 units in length each (for a total of 75 units). Thus, to return to the proper session point, the total time offset is 190+75=265. The Session Manager is able to use the session offset indicator to quickly go the appropriate point in the playlist, and resume play at the proper location.

Those skilled in the art will recognize that many variations of the present invention are possible, than what is disclosed herein. Some variations include the combination of the Session Manager with the VOD server in a single processing system. Alternatively, the functionality can be separated, and communication could occur over public or private communication facilities.

That which is claimed:

1. A system located in a video service provider for providing a video on-demand (“VOD”) program to a viewer comprising
a VOD system comprising:
a session manager comprising a processor configured to:
receive a first request from said viewer, said first request comprising an indication for said VOD program;
establish a first VOD session associated with said viewer, said first VOD session associated with a first playlist comprising dynamically selected advertisements;
terminate said VOD session, wherein said VOD system stores a feature offset value associated with a location in the program at the point where the program was terminated;
receive at said VOD system a second request from said viewer, said second request comprising an indication of said VOD program;
generate a second playlist for a second VOD session for said viewer for said VOD program comprising dynamically selected advertisements;
retrieve from memory of said VOD system said feature offset value;
use said feature offset value to calculate a session offset for said second VOD session; and
stream said second VOD session to said viewer.

2. The system of claim 1 further comprising
a VOD server comprising
data storage configured to store both said video on-demand program and a plurality of advertising assets; and
a second processor configured to provide a stream of said plurality of advertising assets and said video on-demand program upon request from said session manager.

3. The system of claim 1 further comprising a multiplexor configured to receive said stream of said plurality of advertising assets and said on-demand program from said VOD server.

4. The system of claim 1 comprising a video distribution network receiving from said multiplexor and said stream of said plurality of advertising assets to said viewer and transmitting said stream to a set top box of said viewer.

5. The system of claim 1 wherein said session manager processor is further configured to:
record a first time associated with said first request in a memory of said VOD system;
determine a second time associated with said second request of said second request; and
determine said difference between said second time and said first time is less than a predetermined amount.

6. The system of claim 1 wherein said session manager processor is further configured to store a feature a subscriber identifier and a program identifier in association with said feature offset value.

7. The method of claim 6 wherein the session manage processor is configured to calculate a session offset comprises adding at least one advertising segment duration to said feature offset.

8. The method of claim 7 wherein the session manager is configured to transmit said first playlist and said second playlist to said VOD server.

9. The method of claim 8 wherein the first playlist comprises at least one pre-roll ad and a mid-roll ad.

10. A method for providing a video on-demand (“VOD”) program to a viewer by a VOD system located in a video service provider headend, comprising the steps of:
receiving at said VOD system a first request from said viewer, said request comprising an indication for said VOD program;
establishing a first VOD session associated with said viewer, said first VOD session associated with a first playlist comprising dynamically selected advertisements;
terminating said VOD session, wherein said VOD system stores a feature offset value associated with a location in the program at the point where the program was terminated;
receiving at said VOD system a second request from said viewer, said request comprising an indication of said VOD program;
generating a second playlist for a second VOD session for said viewer for said VOD program, said second playlist comprising dynamically selected advertisements;
retrieving from memory of said VOD system said feature offset value;
using said feature offset value to calculate a session offset for said second VOD session; and
streaming said second VOD session to said viewer.

11. The method of claim 10 further comprising the steps of:
recording a first time associated with said first request in a memory of said VOD system;
determining a second time associated with said second request of said second request; and
determining said difference between said second time and said first time is less than a predetermined amount.

12. The method of 10 wherein the step of storing a feature offset value further comprises storing a subscriber identifier and a program identifier.

13. The method of claim 10 wherein the step of using said feature offset value to calculate a session offset comprises adding at least one advertising segment duration to said feature offset.

14. The method of claim 13 wherein said at least one advertising segment comprises at least one pre-roll ad and at least one mid-roll ad.

15. The method of claim 10 wherein the first playlist comprises said program and at least one ad segment, said second playlist comprises said program and at least one other ad segment.

16. The method of claim 10 wherein terminating said first VOD session releases various resources assigned to said first VOD session.

17. A computer readable medium storing instructions causing a processor to perform the steps of:
receiving at a VOD system a first request from said viewer, said request comprising an indication for said VOD program;
establishing a first VOD session associated with said viewer, said first VOD session associated with a first playlist comprising dynamically selected advertisements;
terminating said VOD session, wherein said VOD system stores a feature offset value associated with a location in the program at the point where the program was terminated;
receiving at said VOD system a second request from said viewer, said request comprising an indication of said VOD program;
generating a second playlist for a second VOD session for said viewer for said VOD program;
retrieving from memory of said VOD system said feature offset value;
using said feature offset value to calculate a session offset for said second VOD session; and
streaming said second VOD session to said viewer.

18. The computer readable medium of claim 17 further comprising the steps of:
recording a first time associated with said first request in a memory of said VOD system;
determining a second time associated with said second request of said second request; and
determining said difference between said second time and said first time is less than a predetermined amount.

19. The computer readable medium of claim 17 wherein the step of using said feature offset value to calculate a session offset comprises:
adding at least one advertising segment duration to said feature offset.

20. The computer readable medium of claim 17 further comprising the step of:
releasing various resources assigned to said first VOD session upon terminating of said first VOD session.
